(19) United States
(12) Patent Application Publication
(10) Pub. No.: US 2006/0024514 A1
(43) Pub. Date: Feb. 2, 2006

(54) Electroless plating with nanometer particles

(76) Inventor: Edward McComas, Palm City, FL (US)

Correspondence Address: Sam Silverberg, 6820 32ND ST. NW, Washington, DC, 20015, US

(21) Appl. No.: 11/193,533

(22) Filed: Aug. 1, 2005

Related U.S. Application Data
(63) Continuation-in-part of application No. 10/903,687, filed on Aug. 2, 2004.

(51) Int. Cl. C23C 18/48; B05D 1/18

(52) U.S. Cl. 428/457; 427/443.1; 106/1.22

(57) ABSTRACT

The addition of nanometer particles to electroless metal plating baths reduces or eliminates seeding in the electroless plating baths. The reduced seeding results in less inclusions or pitting in the coating. Usually the maintenance and frequent tank-cleaning schedule can be increased beyond the normal 2-3 day. The properties of the coating can be improved by the co-deposition of the particles into the bath. Properties such as hardness, corrosion resistance, and wear resistance were improved.

This is a continuation in part of U.S. patent application Ser. No. 10/903687 filed Aug. 2, 2005. This invention relates to the addition of nanometer particles to an electroless-plating bath. The nanometer particles provide beneficial results for the coating and the process of electroless coating.

### BACKGROUND OF THE INVENTION

Spontaneous decomposition (seeding) is a problem in the electroless plating industry. Seeding reduces production throughput by limiting the length of time a production-plating tank can be used. When seeding occurs, the plating bath must be removed and the “seeded-out” residue chemically stripped and/or mechanically removed from the plating tanks. This removal, or “clean-out”, normally occurs after every 3-5 days of use. Some applications, especially in the electronics industry where the plated surface must be free of any inclusions, roughness or pits, it is common to remove the plating bath after one day of use. The plating tank is treated with nitric acid to dissolve the debris. Some shops use disposable tank liners to avoid using acids for cleaning. By improving tank and filter designs, some shops are able to increase the length of time between “clean-outs”. Because of the seeding problem associated with electroless plating, plating shops usually employ two production plating tanks so while one is being used for production work, the other is being cleaned by filling with a suitable acid, typically nitric acid, to dissolve the seeded residue.

After the nitric acid is removed and stored away, the tank and filter systems are normally purged with a suitable acid neutralizer such as ammonium hydroxide before the plating bath is returned to the clean plating tank. This operation protects the chemical-plating bath from reacting with the nitric acid, which can severally damage the plating solution.

The nitric acid and ammonium hydroxide solutions are usable for several cycles. However, both require eventual replacement with fresh solutions and both are considered hazardous waste. This waste stream is damaging to the environment.

Nickel boron (NIB) plating is known in the art to be especially troublesome with seeding due to the aggressive nature of sodium borohydride as a reducing agent. Electroless plating baths that use comparatively less aggressive reducing agents such as sodium hypophosphite or dimethylamine borane (DMAB do not suffer as much from seeding as NiB plating baths however seeding does occur even in those baths

The prior art has added DLC (carbonaceous) nanometer particles to electro chemical baths for chrome plating. These nanometer particles do not codeposit into the chrome coating. In electroless plating the nanometer particles codeposit in the coating. U.S. Pat. No. 6,156,390 to Henry et al, teaches adding DLC like particles to an electroless nickel bath using sodium hypophosphite as the reducing agent.

Nanometer diamond-like carbon (here to fore known as DLC) is a product sold by NanoBlox Inc. in Boco Raton, Fla., having a diameter between about 2-8 nanometer. The DLC can be manufactured according to U.S. Pat. Nos. 5,861,349 and 5,916,955. Aqueous dispersions containing an about 10% concentration of these DLC particles are available from Moyco Industries Inc. in Philadelphia, Pa.

### SUMMARY OF THE INVENTION

The addition of nanometer particles to electroless plating baths reduces or eliminates seeding in electroless plating baths. In nickel boron baths, the maintenance and frequent tank-cleaning schedule can be increased beyond the normal 2-3 day interval. In this work twelve (12) days or more of successful plating were accomplished before tank clean-out was required

An objective of the invention is to add nanometer sized particles to electroless metal plus phosphorus plating baths to reduce or eliminate seeding. By doing so this reduced the quantity of inclusions and pitting in the coating.

An objective of this invention is to improve the properties of the coating.. Properties such as hardness, corrosion resistance, and wear resistance were improved.

The co-deposition of nanometer particles with the nickel boron affects the physical structure of all plated samples compared to the microstructure of NIB coatings that did not utilize nanometer particles. The degree of change appears to depend on the aggressive nature of the different reducing agents. The test panels coated from baths reduced with sodium borohydride realized the most significant change to its physical structure while the panels from the DMAB bath resulted in the least change of structure, although still apparent.

### DETAILED DESCRIPTION OF THE INVENTION

The effective size of the nanometer particles is that size that reduces seeding in the bath. The size of the nanometer particles added to an electroless bath should be less than 100 nanometer in diameter in order to reduce seeding or to improve the properties of the coating. The effective size would most likely depend on the chemical composition of the particle and the compositional makeup of the bath. For zirconium oxide the effective size would be less than 40 nanometer. For silicon carbide the size would be less than 30 nanometer. The preferred size appears to be less than 25 nanometer. More preferably the size should be less than 10 nanometer.

The nanometer particles can be added to the bath as dispersion or in solid form. The particle can have functional groups attached to the surface of the particles. When the particles are added in solid form the bath should be sufficiently agitated to ensure that there is a good dispersion. It is expected that a percentage of the particles will agglomerate in the bath or in a dispersing liquid. These agglomerations could possibly reach sizes greater than 5 microns

The presence of nanometer sized particles is believed to prevent localized cells of metal ions and the chemical reducing agent from initiating autocatalytic reduction and forming solid particles that, over time, increase in mass and eventually settle to the plating tank floor and/or the work item surface causing an undesirable roughness and/or wasted chemicals used to plate the plating tank and associated plumbing.

The “effective size” of the nanometer particles is that size that reduces seeding in the bath and/or improves the properties of the coating When an excess amount of nanometer particles is added to the tank, this additional quantity may settle to the bottom of the tank. For example, the addition of greater than 7.5 grams of DLC particles per gallon of plating bath results in some excess DLC material settling to the bottom of the plating tank. The addition of 0.75 gram of DLC (10% of above) per gallon is insufficient to reduce seeding or improve the coating. The preferred amount is about 3-4 grams of DLC per gallon of plating bath.

The properties of the coating deposit are also significantly changed/improved by the utilization of the DLC particles. As a result of adding nm size particles of diamond or “diamond like carbon” to the bath, (all of the following examples were performed using the lead-tungstate stabilized baths) DLC particles are co-deposited into the coating.

Microhardness of the coating changes from about 850-950 (non-DLC coating) up to 1000-1100 (DLC coating) Knoop (25 g, 10 sec) but when heat-treated the microhardness increases from about 1400 (non-DLC coating) up to 1800 (DLC coating) Knoop. The columnar structure becomes more spatially dense with less porosity between columns.

The improvements to the physical properties of the coating deposit by adding nanometer size DLC particles to a typical electroless nickel boron plating bath using lead tungstate as a stabilizer are shown by the following examples.

### EXAMPLE 1

Two separate 15-gallon electroless nickel (NiB) baths were prepared according to U.S. Pat. No. 6,066,406 to McComas using lead tungstate as a stabilizer. One bath was labeled as Bath-1 and the second labeled as Bath-2-DLC.

The Plating Baths were made as follows:
1. 7.5 gallons of deionized water (DI) was added to both 15 gallon plating tanks
2. To each tank, 1362 grams of nickel chloride was added and mixed thoroughly
3. To each bath solution; about 3300 mls of ethylenediamine (EDA) was added, thoroughly mixed and allowed to cool to less than 100° F.
4. To each bath solution; about 1500 grams of sodium hydroxide was added and thoroughly mixed. Both baths were filled to the 15-gallon level with DI water.
5. To the bath labeled Bath-2-DLC; 1120 grams of an aqueous dispersion containing about 10% DLC particles having diameters from 2-8 nanometers were added to about 250 mls of DI water. The particles were made according to U.S. Pat. Nos. 5,861,349 and/or 5,916,955. To this mixture, about 50 mls of ethylenediamine were added and thoroughly mixed. This entire mixture was added to the 15 gallon plating bath.

One gallon of Reducer solution was made as follows;

1. About 1100 grams of sodium hydroxide was added to DI water, thoroughly mixed and allowed to cool to room temperature
1. About 363 grams of sodium borohydride was added to the above solution and thoroughly mixed.
2. The solution was topped-off at the 1-gallon level with water.

A separate Stabilizing Solution was made as follows;

1. 10 grams of Lead tungstate was added to a solution of DI water, EDA, EDTA and sodium hydroxide.

2. The solution was allowed to thoroughly mix and cool to room temperature.

3. The solution was topped-off to the one gallon level with water and labeled as “Stabilizer Solution”

Preparing the Baths For Use;

Both plating solutions were placed in 15 gallon plating tanks with constant mechanical agitation due from a pump and filter system that was constantly run while containing the plating solutions. The solutions were heated by electric resistance type heaters. The thermostats were set and confirmed at 192° F.±2° F.

Five (5) minutes prior to placing prepared coupons in each bath, 120 mls of each reducer and stabilizer solution were added to the plating baths. This addition was repeated every 30 minutes of plating.

Preparing the Coupons/Blank Test Specimens;

Twenty (20) 2×3 inch, mild steel test coupons and 6 medium steel Falex Pins were prepared for plating as follows:

1, Soaked in a detergent cleaner at 160° F. for 5 minutes followed by a thorough rinse

2. Placed in a solution of 30% hydrochloric acid for 2 minutes followed by a rinse.

3. Thoroughly rinsed using DI water.

The Plating;

1. 10 coupons and 3 Falex pins were placed in each plating tank/bath
2. During the plating period, about 6 hours, the deposition rate of each bath was measured and recorded as was the repeated additions of both stabilizer and reducer solutions added to each bath.
3. After about 6 hours of plating, both solutions produced coated samples of nickel boron coating about 0.004 inch thick.

The coupons and Falex pins coated from Bath-2-DLC were immediately noticed as much smoother.

Half of the 20 coupons and half of the 6 Falex pins were randomly selected for heat treatment at 725° F. for 90 minutes. Half were left in the “as plated” condition. The platings were tested and the DLC particles were codeposited into the nickel boron coating.

The Effect on Hardness was Shown by the Following Tests:

1. One randomly selected coupon from each of the four groups was used for micro-hardness testing. To ensure accuracy, 10 indentations were made and averaged together for a single value. Knoop indenters (Hk) were made at 25 gram loads with 10 second dwell.
2. As a baseline, the as-plated sample from Bath-1 was evaluated first. Using the Knoop microhardness method. The Bath-1 panel averaged 1020 Hk.
3. Next, the heat treated Bath-1 sample was evaluated using the Knoop test . The heat treated hardness value averaged 1320 Hk.
4. The plated sample from Bath-2-DLC averaged 1210 Hk.
5. After heat treatingAfter heat-treating the plate sample in step 4 s the Bath-2 DLC sample of step 4 the Hk=1646-1861. This represents an increase in hardness of at least 300 Hk above the heat treated Bath-1 (no DLC) condition..

The effects of DLC on the Physical Structure of the nickel boron deposit was shown by the following tests.
1. One randomly selected coupon from each of the four groups were used for this study.
2. All four were cut in randomly selected areas but generally cut about ⅓ from each end.
3. Each test sample was mounted as to view the coating in cross-section. By using cross sectioning, the coating profile and the interface between coating and coupon substrate can be evaluated
4. As the baseline, the as-plated sampled from Bath-1 nickel boron was evaluated first. The columnar structure of the nickel boron was clearly defined after etching the sample with a standard nitric acid/isopropyl alcohol combination. Clear definition between columns is apparent.
5. The heat-treated specimen of nickel boron showed an improvement to the structure.
6. The as-plated sample from Bath-2-DLC showed a marked improvement to the structure by less porosity and tighter grain structure but no clear signs of codeposited materials such as DLC at 5000× magnification.
7. The heat treated sample of Bath-2-DLC exhibited by far the most significant improvement to the overall physical structure of the coating deposit. No porosity was present and grain/column boundaries were almost non-apparent, as normally a clearly present column boundary line is present. Another significant difference is what appears to be clusters 2-3 microns in diameter of carbon rich mass, either DLC that have become agglomerated during heat treatment, the formation of boron carbides, or another carbon containing compound.

The corrosion resistance of a nickel boron coating is only as good and effective as its ability to seal the surface completely from the corrosive environment. Nickel boron coatings are typically columnar in structure and normally require an underlayer of a barrier coating such as copper or electrolytic nickel to first seal the surface before the nickel boron is applied. Early generations of nickel boron had very little corrosion protection value because of a lack of bath stability that resulted in frequent voids between column boundaries. As new methods of stabilizing the autocatalytic nickel boron deposition reaction occurred, corrosion resistance improved. The addition of DLC reduced porosity, thereby further improving corrosion resistance. This was shown by placing one coupon from each group in a salt spray chamber according to ASTM B-117. The four coupons remained in the salt spray test until surface oxidation (red rust) was visible.
1. The as-plated nickel boron from Bath-1 failed after 500 hours
2. The heat treated coupon from Bath-1 failed after only 120 hours
3. The as-plated coupon from Bath-2-DLC was removed without rust after 1,000 hours
4. The heat-treated coupon from Bath-2-DLC was also removed from the test after 1,000 hours and had no rust on the surface.

A second set of Corrosion Samples coated with Nickel, Boron and Thallium according to U.S. Pat. No. 6,183,546 to McComas were corrosion tested using the same salt spray chamber in accordance with ASTM B-117 specification.. This was compared to an identical bath containing DLC. The results are as follows (time indicates time to failure);

1. Baseline; Nickel, boron & thallium, as plated; less than 24 hours

2. Nickel boron thallium, heat treated; less than 24 hours

3. Nickel, boron thallium plus DLC, as plated, 280 hours

4. Nickel, boron thallium plus DLC heat treated 320 hours

The following tests showed the wear resistance:

The Falex Pin and Vee Accelerated Wear and Friction Machine were used to measure the wear resistance of typical nickel boron sample (using a lead tungstate bath). Coated pins are mounted into a device that rotates the pins at a constant angular velocity regardless of applied load. A pair of Vee blocks is affixed in such a manor that applies equal and constant pressure or load to both sides of the pin while in motion. As the test continues, the load from each Vee block also increases equally on both sides causing a “squeezing effect” to the pin that increases until eventual failure occurs by either the pin fracturing or the failing of the shear pin that holds the pin in place. The test received ASTM approval in the mid-1950's however, for the last 20 years, the metal finishing industry has adopted the test for determining the wear resistance of functional coatings. A coated pin from each of the four groups was tested by allowing the pins to run until failure. The Vee blocks were ASTM standard Falex 1095 high carbon tool steel, heat treat hardened to 52 Rc. White mineral oil, which effectively removed debris but does not offer significant lubrication, was used to isolate the lubricity properties of the coating itself. (All times and pressures indicate failure point).
1. Uncoated baseline Pin, ran 2.2 minutes at 5100 PSI.
2. Baseline; Nickel Boron/Bath-1 as plated; ran 4.5 minutes at 13,200 PSI
3. Bath-1, heat treated; ran 12.5 minutes at 87,000 PSI
4. Bath-2-DLC as plated ran 10.2 minutes at 71,000 PSI
5. Bath-2-DLC heat treated, first trial was stopped after 30 minutes due to Vee block failure at 230,000 PSI
6. Bath-2-DLC heat treated with Vee blocks coated with Bath-1 heat treated, Test ran 23 minutes at max load of 600,000 PSI, shear pin failed, coating was undamaged.

The addition of nanometer size DLC particles add significant improvements to hardness, compressive strength, corrosion resistance and wear resistance of any nickel boron deposit. The significant increase in corrosion resistance of the nickel, boron & thallium coating clearly demonstrates that the addition of these nanometer particles have a large effect on physical structure and mechanical properties of columnar coatings.

The effects of adding nanometer particles to electroless plating bath to reduce seeding or pitting of the coating were shown by the following examples.

### EXAMPLE 2

A one gallon plating bath of electroless nickel boron with and without DLC was made as follows to compare a nickel boron coating

The bath makeup solution without DLC
1. 2500 mls of deionized (DI) water was added to a 4 liter beaker
2. To the water, about 90 grams of nickel chloride was added and thoroughly mixed as the source for metal salts/ions.
3. To the water and nickel, about 225 grams of a complexing agent, ethylenediamine (EDA) was added and thoroughly mixed
4. To the water, nickel and EDA about 100 grams of sodium hydroxide was added to raise pH to 12.5.
5. The total solution level was raised to the 1 gallon level (3783 mls) with DI water

A one-gallon plating bath of electroless nickel boron and with 2-8 nanometer DLC was made as follows;
1. 2500 mls of deionized (DI) water was added to a 4 liter beaker
2. To the water, about 90 grams of nickel chloride was added and thoroughly mixed as the source for metal salts/ions.
3. To the water and nickel, about 225 grams of a complexing agent, ethylenediamine (EDA) was added and thoroughly mixed
4. To the water, nickel and EDA about 100 grams of sodium hydroxide was added to raise pH to 12.5.
5. About 75 grams of an aqueous dispersion containing about 10% DLC particles having diameters from about 2-8 nanometers was added to about 25 mls of DI water. The particles were made according to U.S. Pat. Nos. 5,861,349 and 5,916,955. To this mixture, about 25 mls of ethylenediamine was added and thoroughly mixed. This entire mixture was added to the plating bath.

The total solution level was raised to the 1 gallon level (3783 mls) with DI water. The Reducer solution was made up as follows.
1. 2500 mls of DI water were added to a 4 liter beaker with magnetic stirring rod.
2. To the water, about 1135 grams of sodium hydroxide was added and thoroughly mixed and allowed to cool to room temperature while stirring.
3. To the solution above, about 360 grams of sodium borohydride powder was added, thoroughly mixed and allowed to cool.
4. The total solution level was raised with DI water to 1 gallon

The bath stabilizer solution;

3000 mls of DI water was added to a 4 liter beaker with magnetic stirring rod.

To water, about 25 grams of sodium hydroxide was added To the solution above, 10 grams of lead tungstate (PbWO4) was added while stirring and allowed to thoroughly mix for 10 minutes.

To the solution above, about 80 mls of ethylenediamine (EDA) was added and allowed to mix until the solution became clear in appearance.

Panel Preparation

1. A stirring/hot-plate thermostat was adjusted to heat the plating bath to about 193° F.±1° F.
2. Seven mild steel panels measuring 4 inches×1 inch×0.032 inches thick were degreased using a solvent type cleaner.
3. The panels were engraved 1-7.
4. The same 7 panels were abrasive grit blast using 160 grit aluminum oxide.
5. The same 7 panels were cleaned in a detergent cleaning solution by soaking for about 4 minutes.
6. The panels were thoroughly rinsed in DI water.
7. The panels were then placed in a solution of 30% Hydrochloric acid for about 1 minute after gassing started.
8. The panels were thoroughly rinsed in DI water.
9. The thickness of the panel was measured in the center of the panel, about 1 inch from the drilled end.

The panels were then placed in the center of the one-gallon plating bath void of nanometer particles as made above and time noted. Prior (3-4 minutes) to placing the panels into the plating bath, 10 mls of the Reducer Solution and 10 mls of the Stabilizer Solution were thoroughly mixed together and slowly added to the plating bath. This was repeated every 30 minutes until the desired coating thickness was obtained, about 0.003 inches thick.

The panels were thoroughly rinsed of plating solution and dried using forced air. The plating bath was carefully siphoned/decanted from the top into a clean storage container

Upon examination of the beaker from the bath that did not use DLC, as expected after >5 hours of continuous plating, about 8 grams of solid particles and residue were present at the bottom of the beaker. Some were attached to the Teflon coated magnetic stirring rod but generally dispersed across the bottom of the beaker with a larger amount located at the outer rim of the beaker as would be expected due to the clockwise rotation of the solution.

The control panels had about 0.003 of an inch of nickel boron plating per surface. As expected with electroless plating baths used in a glass beaker without constant filtration, one side of each panel had more surface roughness than the other because one side would be facing the oncoming rotation of the solution.

The solid particles were analyzed by ICP and determined to be about 95% nickel and 5% boron by weight. This would be indicative of a nickel boron deposit as described in U.S. Pat. No: 6,066,406

Using SEM-EDAX to examine the solid debris, residue and particles located at the bottom of the beaker; no center of any particle was visually obvious even under high magnification supporting random nucleation of each particle. In addition, no other elements were found within the solid debris particles supporting the fact that the solid particles are the result of spontaneous decomposition and not the result of another element entering the bath and initiating the decomposition.

### EXAMPLE 3

The same experiment as in example 2 was repeated using the nickel boron bath made up with the about 2-8 nanometer particles

The panels were thoroughly rinsed of plating solution and dried using forced air. The plating bath was carefully siphoned/decanted from the top into a clean storage container Upon examination of the beaker after >5 hours of continuous plating, less than 1 gram of solid nickel born particles and residue were present at the bottom of the beaker. Only a slight amount, less than 0.05 grams were attached to the magnetic stirring rod, with even less located at the outer rim of the beaker.

Examining the plated panels, they had about 0.003 of an inch of nickel boron plating per surface. After plating for 5 hours without filtration a very rough surface would normally be expected, especially on the surface that is facing the flow of the bath however all panels were very smooth with no pits, attached particles or debris.

### EXAMPLE 4

The following example contrasts the effect of using 2-8 nanometer diamond like particles codeposited with Nickel Boron and Thallium when thallium compounds are used as a stabilizer

1. The nickel boron bath makeup bath was the same bath as used in example 2 without nanometer particles;

2 The Reducer solution was the same as in in example 2

3. The bath stabilizer solution;
1. 3000 mls of DI water was added to a 4 liter beaker with magnetic stirring rod.
2. To water, about 25 grams of sodium hydroxide was added
3. To the solution above, 10 grams of thallium sulfate and 10 grams of thallium nitrate were added while stirring and allowed to thoroughly mix for 10 minutes.(See U.S. Pat. No. 6,183,546)
4. To the solution above, about 80 mls of ethylenediamine (EDA) was added and allowed to mix until the solution became clear in appearance.

The panels were prepared as in example 2
1. The panels were then placed in the center of the plating bath and the time noted.
2. Prior (3-4 minutes) to placing the panels into the plating bath, 10 mls of the Reducer Solution and 10 mls of the Stabilizer Solution were thoroughly mixed together and slowly added to the plating bath. This was repeated every 30 minutes until the desired coating thickness was obtained, about 0.003 inches thick.

The panels were thoroughly rinsed of plating solution and dried using forced air. The plating bath was carefully siphoned/decanted from the top into a clean storage container.

Upon examination of the beaker, as expected after >5 hours of continuous plating, about 7 grams of particles and residue were present at the bottom of the beaker. Some were attached to the Teflon coated magnetic stirring rod but generally dispersed across the bottom of the beaker with a larger amount located at the outer rim of the beaker as would be expected due to the clockwise rotation of the solution.

Examining the plated panels, they had about 0.0029 of an inch of nickel boron plating per surface. As expected with electroless plating baths used in a glass beaker without constant filtration, one side of each panel had more surface roughness than the other because one side would be the facing the oncoming rotation of the solution.

The solid particles were analyzed by ICP and determined to be about 93% nickel and 4% boron and 3% thallium by weight. This would be indicative of a nickel boron thallium deposit as described in U.S. Pat. No. 6,183,546

### EXAMPLE 5

This example is identical to example 4 except the plating nickel boron make up bath has having about 2-8 nanometer DLC used in the example 2.

The panels were thoroughly rinsed of plating solution and dried using forced air. The plating bath was carefully siphoned/decanted from the top into a clean storage container. Upon examination of the beaker after >5 hours of continuous plating, less than 1 gram of solid nickel born particles and residue were present at the bottom of the beaker. Only a slight amount, less than 0.05 grams were attached to the magnetic stirring rod, a even less located at the outer rim of the beaker.

Examining the plated panels, they had about 0.003 of an inch of nickel boron plating per surface. After plating for 5 hours without filtration, a very rough surface would normally be expected, especially on the surface that is facing the flow of bath however, all panels were very smooth with no pits, attached particles or debris. This is the exact opposite result of Bath #1 that did not contain 2-8 nm particles.

### EXAMPLE 6

The effect of DLC particles on a DMAB Electroless Nickel Boron Plating Bath is shown by the following comparative example.

A bath was made up according to McDermid Specifications without DLC particles using a McDermid bath (niklad-752).

Bath Make-Up, One Gallon;

1. To 2000 mls of DI water, 85 grams of Nickel Sulfate was mixed.

2. To the solution, 50 grams of Sodium Acetate was added and mixed.

3. While mixing, 13.5 grams of Dimethylamine Borane (DMAB) was added and mixed.

4. As a stabilizer, 6.8 milligrams of Lead Acetate was added and topped-off to 1 gallon level.

5. The pH was adjusted to 6.1

6. The temperature was set at 160° F.

The Panels Were Prepared as in Example 2

The panels were then placed in the center of the plating bath and the time noted. The panels were thoroughly rinsed of plating solution and dried using forced air.

The plating bath was carefully siphoned/decanted from the top into a clean storage container and labeled.

DMAB plating baths are known in the art to deposit slowly as a result of a less aggressive reduction reaction compared to sodium borohydride. Even still, after examination of the beaker, as expected after >5 hours of continuous plating, about 2 grams of particles and residue were present at the bottom of the beaker. Some were attached to the Teflon coated magnetic stirring rod but generally dispersed across the bottom of the beaker with a larger amount located at the outer rim of the beaker as would be expected due to the clockwise rotation of the solution.

Examining the plated panels, they had about 0.00035 of an inch of nickel boron plating per surface. As expected with electroless plating baths used in a glass beaker without constant filtration, one side of each panel had more surface roughness than the other because one side would be the facing the oncoming rotation of the solution. 5 of 7 panels had pitting on one or both sides in a random pattern.

The solid particles were analyzed by ICP and determined to be about 98% nickel and 2% boron by weight. This would be indicative of a nickel boron deposit.

Using SEM-EDAX to examine the solid debris, residue and particles located at the bottom of the beaker no center of any particle was visually obvious even under high magnification supporting random nucleation of each particle. In addition, no other elements were found within the solid debris particles supporting the fact that the solid particles are the result of spontaneous decomposition and not the result of another element entering the bath and initiating the decomposition.

### EXAMPLE 7

The example is identical to example 6 except the make up bath has DLC particles as shown below.

Bath Make-up, one gallon;
1. To 2000 mls of DI water, 85 grams of Nickel Sulfate was mixed.
2. To the solution, 50 grams of Sodium Acetate was added and mixed.
3. While mixing, 13.5 grams of Dimethylamine Borane was added and mixed.
4. As a stabilizer, 6.8 milligrams of Lead Acetate was added.
6. 75 grams of an aqueous dispersion containing about 10% DLC particles having diameters from about 2-8 nanometers was added to about 25 mls of DI water. The particles were made according to U.S. Pat. Nos. 5,861,349 and 5,916,955. To this mixture, about 25 mls of ethylenediamine was added and thoroughly mixed. This entire mixture was added to the plating bath. The bath level was increased to 1 gallon by adding DI water.
5. The pH was adjusted to 6.1
6. The temperature was set at 160° F.

The panels were thoroughly rinsed of plating solution and dried using forced air.

The plating bath was carefully siphoned/decanted from the top into a clean storage container.

Upon examination of the beaker, no plate-out or other debris was found at the bottom or sides of the beaker.

Examining the plated panels, they had about 0.00032 of an inch of nickel boron plating per surface.

The coating was smooth and pit free on all sides.

### EXAMPLE 8

The effect of DLC particles on a Standard Electroless Nickel High-Phosphorus plating bath is shown by the following comparative examples.;

Bath Make-up; (one gallon)
1. 95 grams of Nickel Sulfate was added to 3000 mls of DI water
2. To the solution, 58 grams of sodium acetate was added
3. 100 grams of Sodium Hypophosphite was added and thoroughly stirred.
4. To the solution, 60 milligrams of Lead Acetate was added and the solution topped-off to the one gallon level while mixing.
5. The bath was then placed on a stirring hot plate and heated to approximately 188° F. The container was labeled as Bath #6.
6. The pH was checked before using and found to be 4.5. During use, the pH required adjustment with ammonium hydroxide to maintain a range between 4.4-4.6.

The panels were prepared as in example 2.
1. The panels were then placed in the center of the plating bath and the time noted.
2. The panels were allowed to plate for 6 hours during which time the deposition rate was monitored and averaged 0.0005 per side, per hour of plating.
3. After plating, the panels were forced air dried.

The panels were thoroughly rinsed of plating solution and dried using forced air.

The plating bath in the beaker was carefully siphoned/decanted from the top into a clean storage container. Upon examination of the beaker, as expected after >5 hours of continuous plating, about 2 grams of solid nickel-phosphorus particles and residue were present at the bottom of the beaker. Some were attached to the Teflon coated magnetic stirring rod but generally dispersed across the bottom of the beaker with a larger amount located at the outer rim of the beaker as would be expected due to the clockwise rotation of the solution.

The plated panels measured about 0.0026 of an inch of nickel-phosphorus plating per surface. As expected with electroless plating baths used in a glass beaker without constant filtration, one side of each panel had more surface roughness than the other because one side would be the facing the oncoming rotation of the solution. Both panels had pits. The solid particles were analyzed by SEM-EDAX and determined to be about 89% nickel and 11% phosphorus by weight. This would be indicative of a “high-phoss” electroless nickel phosphorus deposit.

Using SEM-EDAX to examine the solid debris, residue and particles located at the bottom of the beaker no center of any particle was visually obvious even under high magnification supporting random nucleation of each particle. In addition, no other elements were present within the solid debris particles supporting the fact that the solid particles are the result of spontaneous decomposition and not the result of another element entering the bath and initiating the decomposition.

### EXAMPLE 9

The effect of the addition of DLC on Standard Electroless Nickel High-Phosphorus plating bath is shown by this example. The same procedure was used as in example 8 except the addition of DLC to the make up bath.

Bath Make-up; (one gallon)
1. 95 grams of Nickel Sulfate was added to 3000 mls of DI water
2. To the solution, 58 grams of sodium acetate was added
3. 100 grams of Sodium Hypophosphite was added and thoroughly stirred.
4. To the solution, 60 milligrams of Lead Acetate was added and the solution topped-off to the one gallon level while mixing.
5. The bath was then placed on a stirring hot plate and heated to approximately 188° F. The container was labeled as Bath #6.
6. The pH was checked before using and found to be 4.5,
7. 75 grams of an aqueous dispersion containing about 10% DLC particles having diameters from about 2-8 nanometers was added to about 25 mls of DI water. The particles were made according to U.S. Pat. Nos. 5,861,349 and 5,916,955. To this mixture, about 25 mls of ethylenediamine was added and thoroughly mixed. This entire mixture was added to the plating bath. The was mixed until the bath had a uniform milky green appearance,

The panels were thoroughly rinsed of plating solution and dried using forced air.

The plating bath was carefully siphoned/decanted from the top into a clean storage container and labeled. Upon examination of the beaker, no debris was present on the beaker sides or bottom. One particle of unknown origin measuring about 0.001 inch was attached to the Teflon coated magnet.

Examining the plated panels, they measured to indicate about 0.0027 of an inch of nickel-phosphorus plating per surface. All panels were identical in smoothness and no pits or other imperfections were found.

One single particle was found but did not have enough mass for analysis.

### EXAMPLE 10

The effect of the addition of DLC on Standard Electroless Nickel Medium-Phosphorus plating bath is shown by this example. The same procedure was used as in examples 8 and 9 except the make up bath and the addition of DLC to the make up bath is different.

A one-gallon plating bath was made as follows;
1. 2000 mls of DI water was added to a 4 liter beaker.
2. To the water, about 110 grams of nickel sulfate was added and thoroughly mixed.
3. To the water and nickel solution a complexing agent of about 285 grams of Sodium Citrate was added and thoroughly mixed.
4. To the same solution, about 90 grams of a reducing agent, sodium Hypophosphite was added and thoroughly mixed.
5. To the same solution about 5.5 milligrams of Thiourea was added and thoroughly mixed.
6. The pH was monitored and adjusted to 5.2 with sulfuric acid as needed
7. The bath was topped off to one gallon and labeled.

The panels were prepared as in example 2

The thickness of the panel was measured in the center of the panel, about 1 inch from the drilled end. The panels were thoroughly rinsed of plating solution and dried using forced air.

The plating bath in the beaker was carefully siphoned/decanted from the top into a clean storage container and labeled as Bath #2.

Upon examination of the beaker, as expected after >5 hours of continuous plating, about 1.4 grams of solid nickel-phosphorus particles and residue were present at the bottom of the beaker. Some were attached to the Teflon coated magnetic stirring rod but generally dispersed across the bottom of the beaker with a larger amount located at the outer rim of the beaker as would be expected due to the clockwise rotation of the solution.

The plated panels had about 0.0022 of an inch of nickel-phosphorus plating per surface. As expected with electroless plating baths used in a glass beaker without constant filtration, one side of each panel had more surface roughness than the other because one side would be the facing the oncoming rotation of the solution.

The solid particles at the bottom of the bath were analyzed by SEM-EDAX and determined to be about 94% nickel and 6% phosphorus by weight. This would be indicative of a “medium-phoss” electroless nickel phosphorus deposit. Using SEM-EDAX to examine the solid debris, residue and particles located at the bottom of the beaker for other than nickel phoss compound resulted in no visually observed particles even under high magnification supporting random nucleation no such particle was seen.

### EXAMPLE 11

Standard Electroless Nickel-Medium-Phosphorus Plating bath; with DLC particles;

One gallon make-up
1. 2000 mls of DI water was added to a 4 liter beaker.
2. To the water, about 110 grams of nickel sulfate was added and thoroughly mixed.
3. To the water and nickel solution a complexing agent of about 285 grams of Sodium Citrate was added and thoroughly mixed.
4. To the same solution, about 90 grams of a reducing agent, sodium Hypophosphite was added and thoroughly mixed.
5. To the same solution about 5.5 milligrams of Thiourea was added and thoroughly mixed.
6. 75 grams of an aqueous dispersion containing about 10% DLC particles having diameters from about 2-8 nanometers was added to about 25 mls of DI water. The particles were made according to U.S. Pat. Nos. 5,861,349 and 5,916,955. To this mixture, about 25 mls of ethylenediamine was added and thoroughly mixed. The resulting mixture was added to the bath and allowed to thoroughly mix.
7. The pH was monitored and adjusted to 5.2 with sulfuric acid as needed.
8. The bath was topped off to one gallon and labeled.

The thickness of the panel was measured in the center of the panel, about 1 inch from the drilled end. The thickness was recorded.

The panels were thoroughly rinsed of plating solution and dried using forced air. The plating bath was carefully siphoned/decanted from the top into a clean storage container.

Upon examination of the beaker, no plate-out or other debris was present at the bottom or sides of the beaker.

The plated panels measured about 0.0022 of an inch of nickel-phosphorus plating per surface. The coating was smooth and pit free on both sides.

What is claimed:

1. An electroless metal boron plating bath comprising:
an effective amount of reducing agent,
an effective amount of nanometer particles having a diameter so that the seeding in the bath is reduced
an effective amount of complexing agent, and
an effective amount of metal ions.

2. A bath according to claim 1 wherein the diameter of a nanometer particle is less than 100 nanometer prior to being introduced into the bath or before the nanometer particle agglomerate in a liquid prior to being introduced in the bath.

3. A bath according to claim 1 wherein diameter of a nanometer particle is less than 25 nanometer prior to being introduced into the bath or before the nanometer particle agglomerates in a liquid prior to being introduced in the bath.

4. A bath according to claim 3 wherein diameter of a nanometer particle is less than 10 nanometer prior to being introduced into the bath or before the nanometer particle agglomerates in a liquid prior to being introduced in the bath.

5. A bath according to claim 1 wherein the nanometer particles are hard particles.

6. A bath according to claim 5 wherein the nanometer particles are selected from zirconium oxide and silicon carbide or DLC.

7. A bath according to claim 6 wherein the DLC particles are introduced in the bath by mixing DLC particles having diameters between about 2-8 nanometer with a dispersing liquid and then adding the mixture to the bath.

8. A bath according to claim 1 wherein the particles contain functional groups.

9. A bath according to claim 1 wherein the bath is a nickel boron bath and wherein the reducing agent is a boron compound

10. A bath according to claim 9 wherein the nanometer particles are DLC particles having diameters between about 2-8 nanometer prior to being introduced into the bath or before the nanometer particles agglomerate in a liquid prior to being introduced in the bath.

11. A bath according to claim 1 consisting essentially of
an effective amount of boron reducing agent,
an effective amount of nanometer particles having a diameter so that the seeding in the bath is reduced
an effective amount of complexing agent, and
an effective amount of nickel ions.

12. A process of electroless plating comprising:
plating an article in a bath comprising,
an effective amount of a boron reducing agent,
an effective amount of nanometer particles having a diameter so that the seeding in the bath is reduced
an effective amount of complexing agent, and
an effective amount of metal ions.

13. A process according to claim 12 wherein the diameter of a nanometer particle is less than 100 nanometer prior to being introduced into the bath or before a nanometer particle agglomerates in a liquid prior to being introduced in the bath.

14. A process according to claim 13 wherein the diameter of a nanometer particle is less than 25 nanometer prior to being introduced into the bath or before the nanometer particle agglomerates in a liquid prior to being introduced in the bath.

15. A process according to claim 14 wherein the diameter of a nanometer particle is less than 10 nanometer prior to being introduced into the bath or before the nanometer particle agglomerates in a liquid prior to being introduced in the bath.

16. A process according to claim 11 wherein the nanometer particles are hard particles.

17. A process according to claim 15 wherein the nanometer particles are selected from zirconium oxide and silicon carbide or DLC.

18. A process according to claim 12 wherein the nanometer particles are DLC particles having diameters between about 2-8 nanometer prior to being introduced into the bath or before the nanometer particles have agglomerated in a liquid prior to being introduced in the bath and the metal ions are nickel ions.

19. A process according to claim 12 wherein particles contain functional groups.

20. A process according to claim 12 wherein the nanometer particles are DLC particles having diameters between about 2-8 nanometer prior to being introduced into the bath or before the nanometer particles agglomerate in a liquid prior to being introduced in the bath

21. A product produced by the process of claim 12 wherein the nanometer particles are co-deposited in the coating.

22. A product produced by the process of claim 20 wherein the nanometer particles are co-deposited in the coating.

23. An electroless deposited metal boron coating comprising a codeposited nanometer particle that had a diameter that reduced seeding during the electroless deposition

24. An electroless deposited metal boron coating according to claim 23 wherein the nanometer particles are DLC particles having diameters between about 2-8 nanometer prior to being introduced into a bath for electroless deposition or before the nanometer particles agglomerate in a liquid prior to being introduced in a bath for electroless deposition

25. An electroless deposited metal coating according to claim 23 wherein the coating contains boron carbide.

26. An electroless deposited metal coating according to claim 23 where in the metal is nickel and the particles contains functional groups.

27. A process of electroless plating metal phosphorous comprising:
plating an article in a bath comprising,
an effective amount of a reducing agent,
an effective amount of nanometer particles having a diameter so that the seeding in the bath is reduced
an effective amount of complexing agent, and
an effective amount of metal ions.
continuing the plating beyond the point seeding would normally occur without the presence of the nanometer particle thereby extending the life of the bath without seeding.

28. A process of forming an, aqueous alkaline electroless bath comprising mixing an effective amount of boron reducing agent,
an effective amount of nanometer particles having a diameter so that the seeding in the bath is reduced
an effective amount of complexing agent, and
an effective amount of nickel ions.

29. A process according to claim 28 particles wherein DLC particles are introduced in the bath by mixing DLC particles having diameters between about 2-8 nanometer with a dispersing liquid and then adding the mixture to the bath.
